(19) United States
(12) Patent Application Publication
(10) Pub. No.: US 2023/0299549 A1
(43) Pub. Date: Sep. 21, 2023

(54) FIBER GRATING APPARATUS AND SENSOR DEVICE

(71) Applicant: Shphotonics Ltd, Suzhou (CN)

(72) Inventors: Bing QIU, Suzhou (CN); Lei SUN, Suzhou (CN)

(21) Appl. No.: 18/185,777

(22) Filed: Mar. 17, 2023

(30) Foreign Application Priority Data
Mar. 18, 2022 (CN) 202210267393.7

(51) Int. Cl. H01S 3/067; H01S 3/10

(52) U.S. Cl. CPC H01S 3/0675; H01S 3/06712; H01S 3/10053

(57) ABSTRACT

A fiber grating apparatus includes a first optical fiber, an optical wave assembly coupled to the first optical fiber and having grating function, and a second optical fiber coupled to the optical wave assembly. The optical wave assembly includes a first substrate, a metalens assembly, a filter, and a second substrate. The first optical fiber, the optical wave assembly, and the second optical fiber are arranged on a same plane.

### CROSS-REFERENCE TO RELATED APPLICATION

This application claims priority to Chinese Application No. 202210267393.7, filed on Mar. 18, 2022, the entire content of which is incorporated herein by reference.

### TECHNICAL FIELD

The present disclosure relates to sensors and, more particularly, to a fiber grating apparatus and a sensor device.

### BACKGROUND

Fiber grating, as a passive filter device, is a grating formed by periodically modulating the refractive index of the fiber core in an axial direction. Fiber grating has small size and small fusion loss, is fully compatible with optical fibers, and can be embedded in smart materials. Further, the resonant wavelength of fiber grating is sensitive to changes in external environments such as temperature, strain, refractive index, and concentration. Therefore, fiber gratings are widely used in fiber lasers, optical fiber communication, and sensors.

In related technologies, the fabrication of fiber grating utilizes the photosensitivity of the fiber material, in which a coherent field pattern of incident light is written into a fiber core by ultraviolet light exposure to generate a periodic change of the refractive index along the axial direction of the fiber core, thus forming a permanent spatial phase grating. However, fiber gratings need to be independently fabricated using a specific process, resulting in high fabrication costs, low output, and complex grating fabrication processes. Further, the material of the fiber core is usually silicon oxide, which has a relatively low temperature coefficient, causing the sensing performance of fiber gratings to be poor.

### SUMMARY

In accordance with the disclosure, there is provided a fiber grating apparatus including a first optical fiber, an optical wave assembly coupled to the first optical fiber and having grating function, and a second optical fiber coupled to the optical wave assembly. The optical wave assembly includes a first substrate, a metalens assembly, a filter, and a second substrate. The first optical fiber, the optical wave assembly, and the second optical fiber are arranged on a same plane.

Also in accordance with the disclosure, there is provided a sensor device including a fiber grating apparatus. The fiber grating apparatus includes a first optical fiber, an optical wave assembly coupled to the first optical fiber and having grating function, and a second optical fiber coupled to the optical wave assembly. The optical wave assembly includes a first substrate, a metalens assembly, a filter, and a second substrate. The first optical fiber, the optical wave assembly, and the second optical fiber are arranged on a same plane.

### BRIEF DESCRIPTION OF THE DRAWINGS

FIG. 1 is a schematic diagram of an example fiber grating apparatus consistent with the disclosure.

FIG. 2 is a schematic diagram of another example fiber grating apparatus consistent with the disclosure.

FIG. 3 is a schematic diagram of another example fiber grating apparatus consistent with the disclosure.

FIG. 4 is a schematic diagram of another example fiber grating apparatus consistent with the disclosure.

FIG. 5 is a schematic diagram of another example fiber grating apparatus consistent with the disclosure.

FIG. 6 is a schematic diagram of another example fiber grating apparatus consistent with the disclosure.

FIG. 7 is a schematic diagram of another example fiber grating apparatus consistent with the disclosure.

### REFERENCE NUMERALS

First optical fiber 100;
Optical wave assembly 200; First substrate 210; First metalens assembly 220; First filter 230, Second substrate 240; First metalens 222, second metalens 250, Third metalens 260; Protective film 221; Second filter 223;
Second optical fiber 300;
Phase retarder 400.

### DETAILED DESCRIPTION OF THE EMBODIMENTS

Embodiments are described below in details for a better understanding of the disclosure. It will be apparent, however, to one skilled in the art that the disclosure can be implemented without these details. Terms such as “system,” “apparatus,” “device,” “unit,” and/or “module” used in this disclosure are to distinguish between different components, elements, parts, or assemblies, and they can be replaced by other terms where proper.

In this disclosure, when a device, unit, or module is referred to as being “on,” “connected to,” or “coupled to” another device, unit, or module, the former can be directly on, connected or coupled to, or communicate with the latter, or there may be intermediate device, unit, or module, unless the context clearly suggests otherwise. As used herein, the term “and/or” includes any and all combinations of one or more of the associated listed items.

The terminology used in the present disclosure is for describing specific embodiments only, and does not limit the scope of the present disclosure. In the present disclosure, terms such as “a,” “an,” and/or “the” do not necessarily mean singular, and can also include plural, unless the context clearly indicates otherwise. In general, terms such as “include,” “comprise,” and “contain” suggest the inclusion of clearly listed features, items, steps, operations, elements, and/or components, and do not suggest an exclusive list, while other features, items, steps, operations, elements, and/or components can also be included.

Features and characteristics, methods of operations, functions of relevant elements of structures, combinations of parts, and economies of manufacture of the present application can be better understood with reference to the following description and drawings, which form a part of the disclosure. The drawings are only for the purpose of illustration and description, and are not intended to limit the scope of the present disclosure. The drawings are not necessarily drawn to scale.

Various structural diagrams are used in this disclosure to illustrate various modifications of the embodiments according to the disclosure. The structures are not intended to limit the present disclosure.

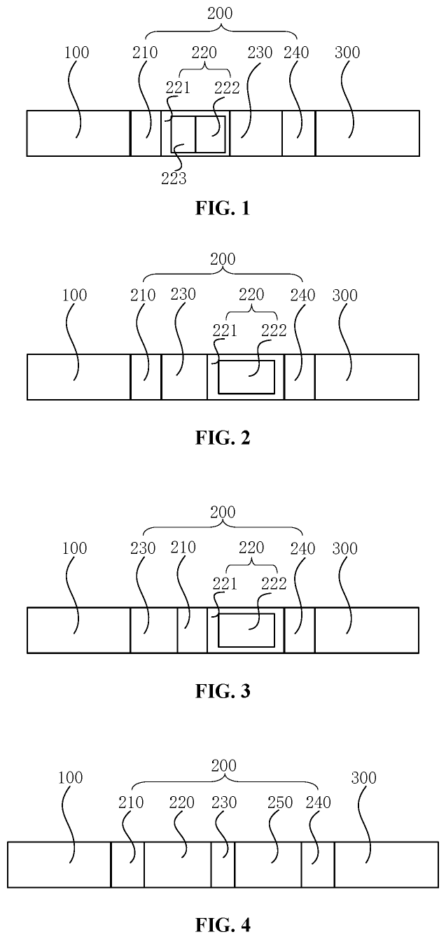

FIG. 1 is a schematic structural diagram of an example of fiber grating apparatuses consistent with the disclosure. As shown in FIG. 1, the fiber grating apparatus a first optical fiber 100, an optical wave assembly 200 with grating function, and a second optical fiber 300, which are coupled in sequence. The optical wave assembly 200 includes a first substrate 210, a first metalens assembly 220, a first filter 230, and a second substrate 240. The first optical fiber 100, the optical wave assembly 200, and the second optical fiber 300 are on a same axis, e.g., they share a same optical axis. Light is incident from the first optical fiber 100, passes through the optical wave assembly 200, and exits to the second optical fiber 300. Therefore, the production cost is reduced, and the optical fiber grating does not need to be independently fabricated using a specific process. As such, the complexity of the grating fabrication process is reduced, and the sensing performance of the optical fiber grating is improved. The sensing performance can be adjusted by changing the material of the first filter 230.

In some embodiments, the first optical fiber 100, the optical wave assembly 200, and the second optical fiber 300 are on a same horizontal plane, and an optical axis of the first optical fiber 100, the optical wave assembly 200, and the second optical fiber 300 does not coincide with an optical axis of the first metalens assembly 220. For example, an angle exists between the optical axis of the first optical fiber 100, the optical wave assembly 200, and the second optical fiber 300 and the optical axis of the first metalens assembly 220. The existence of the angle makes it possible that no part of the light exiting from the optical wave assembly 200 to the first metalens assembly 220 is reflected back to the optical wave assembly 200, thereby avoiding light loss.

Fiber gratings consistent with the disclosure can be used to make, for example, strain sensors, temperature sensors, bandpass filters, add-drop multiplexers, and demultiplexers for wavelength division multiplexers, which can be uniform fiber gratings. Fiber gratings consistent with the disclosure can also be used to make uniform long-period fiber gratings, for example, sensors such as microbending sensors and refractive index sensors, erbium-doped fiber amplifiers, gain flatters, mode converters, and band-stop filters. Fiber gratings consistent with the disclosure can also be used to make apodized fiber gratings (such as dense wavelength division multiplexers), phase-shifting fiber gratings (such as band-pass filters), sampling fiber gratings (such as comb filters, which are add-drop multiplexing devices in wavelength division multiplexing (wdm) systems), chirped fiber gratings (such as dispersion compensators), and large chirped fiber gratings. Dispersion compensation (pulse widening/compression) is one of the key technologies in the field of ultrafast lasers. Fiber gratings consistent with the disclosure can be used in stable synthesis of multi-wavelength light sources, shaping of short fiber lasers, and the production of stable continuous wave and adjustable mode-locked external cavity semiconductor lasers. In the fiber grating sensing demodulation technology, large chirped fiber gratings with a special reflection waveform are also needed.

In some embodiments, the first substrate 210, the first metalens assembly 220, the first filter 230, and the second substrate 240 are sequentially coupled to each other. The first substrate 210, the first metalens assembly 220, the first filter 230, and the second substrate 240 are on the same axis along the first optical fiber 100, and the second substrate 240 is coupled to the second optical fiber 300.

In some embodiments, the first metalens assembly 220 includes a first metalens 222 or the first metalens 222 and a second filter 223. The first metalens assembly 220 further includes a protective film 221. In the embodiments that the first metalens assembly 220 includes the first metalens 222 and the second filter 223, the second filter 223 is arranged on a surface of the first metalens 222, and the protective film 221 completely wraps the second filter 223 and the first metalens 222. In this scenario, the first filter 230 can be omitted, i.e., the optical wave assembly 200 can include the first substrate 210, the first metalens lens 222, the second filter 223, and the second substrate 240. Arranging the second filter 223 on the surface of the first metalens 222 and omitting the first filter 230 can save costs, expand the space of the light wave assembly 200, and allow other components to be added. The first substrate 210 and the second substrate 240 can increase the thickness of the light transmission components and the focal length can be adjusted.

In some embodiments, as shown in FIG. 2, the first filter 230 is arranged on the first substrate 210, and the first optical fiber 100, the first substrate 210, the first filter 230, the first metalens assembly 220, the second substrate 240, and the second optical fiber 300 are coupled in sequence. In some embodiments, as shown in FIG. 3, the first filter 230 is arranged on the first optical fiber 100, and the first optical fiber 100, the first filter 230, the first substrate 210, the first metalens assembly 220, the second substrate 240, and the second optical fiber 300 are coupled in sequence. When the first filter 230 is provided on the first substrate 210, the cost can be saved, and the space of the optical wave component 200 can be expanded, allowing other components to be added. When the first filter 230 is arranged on the first optical fiber 100, optical fiber sensing function can be realized, thereby improving the sensing performance.

In some embodiments, as shown in FIG. 4, the fiber grating apparatus further includes a second metalens 250. The second metalens 250 is arranged between the first filter 230 and the second substrate 240, and the second metalens 250 is coupled to both the first filter 230 and the second substrate 240. Inclusion of the first metalens assembly 220 and the second metalens 250 allows light entering and exiting the first filter 230 to be collimated at an angle of 90 degrees. Further, a filter with most suitable material can be used as the first filter 230, i.e., the first filter 230 can be changed at any time. Therefore, sensing performance is further improved.

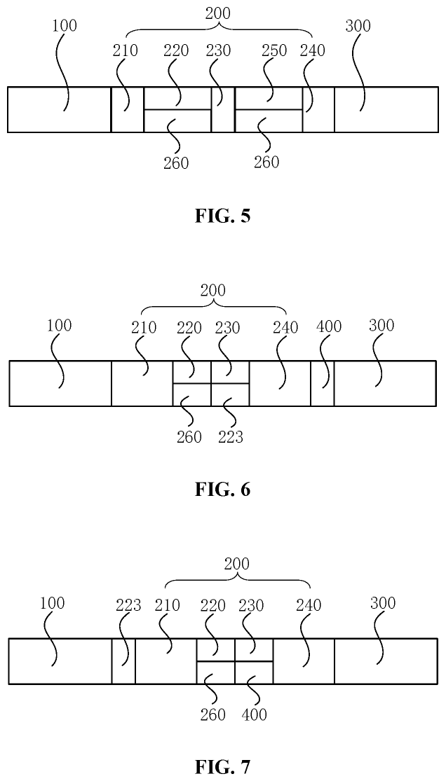

In some embodiments, as shown in FIG. 5, the fiber grating apparatus further includes a third metalens 260. In some embodiments, the third metalens 260 and the first metalens assembly 220 are arranged side by side with each other, and between the first substrate 210 and the first filter 230. In some embodiments, the third metalens 260 and the second metalens 250 are arranged side by side with each other, and between the second substrate 240 and the first filter 230. In some embodiments, the fiber grating apparatus includes two third metalens 260. One of the two third metalenses 260 is arranged side by side with the first metalens assembly 220 and between the first substrate 210 and the first filter 230. Another one of the two third metalenses 260 is arranged side by side with the second metalens 250 and between the second substrate 240 and the first filter 230. Further inclusion of the third metalens 260 to form a first metalens array with the first metalens assembly 220, and/or further inclusion of the third metalens 260 to form a second metalens array with the second metalens 250, further increases the light collimation efficiency, thereby improving the sensing performance.

In some embodiments, as shown in FIGS. 6 and 7, the fiber grating apparatus further includes a second filter 223 and a phase retarder 400. In some embodiments, as shown in FIG. 6, the second filter 223 and the first filter 230 are arranged side by side to form a filter array, and the filter array is arranged corresponding to the first metalens array. Arranging the phase retarder 400 between the second substrate 240 and the second metalens 250 allows achieving of multiple grating effects of different wavelengths in a single apparatus, which greatly improves the sensing and/or communication performance of the apparatus.

In some embodiments, as shown in FIG. 7, the second filter 223 is arranged between the first optical fiber 100 and the first substrate 210. The first filter 230 and the phase retarder 400 are arranged side by side with each other, and are arranged corresponding to the first metalens array. The first filter 230 and the phase retarder 400 can convert light with linear polarization to light with circular polarization. Further, the effect of a grating can be realized. Thus, multiple functions are integrated in one apparatus, which brings convenience to users.

The present disclosure also provides a sensor device, which includes a fiber grating apparatus consistent with the disclosure, such as one of the above-described example fiber grating apparatuses. The sensor device further includes a first waveguide and a second waveguide. In some embodiments, the sensor device includes a first optical fiber, an optical wave assembly having grating function, and the first waveguide or the second waveguide, coupled in sequence. In some embodiments, the sensor device includes the first waveguide, the optical wave assembly having grating function, and the second waveguide, coupled in sequence. The sensor device of the present disclosure has a low production cost and does not need a specific process to independently fabricate the optical fiber grating, which reduces the complexity of the fabrication process of the optical fiber grating and improves the sensing performance of the optical fiber grating.

The above specific implementation manners are only used to illustrate or explain the principle of the present disclosure, but not to limit the present disclosure. Therefore, any modification, equivalent replacement, improvement, etc., made without departing from the spirit and scope of the present disclosure shall fall within the scope of the present disclosure. Furthermore, the claims are intended to cover all changes and modifications that fall within the scope and metes and bounds, or equivalents of such scope and metes and bounds, of the claims.

What is claimed is:

1. A fiber grating apparatus comprising:
a first optical fiber;
an optical wave assembly coupled to the first optical fiber and having grating function, the optical wave assembly including a first substrate, a metalens assembly, a filter, and a second substrate; and
a second optical fiber coupled to the optical wave assembly;
wherein the first optical fiber, the optical wave assembly, and the second optical fiber are arranged on a same plane.

2. The fiber grating apparatus of claim 1, wherein:
the first substrate, the metalens assembly, the filber, and the second substrate are coupled in sequence;
the first substrate, the metalens assembly, the filber, and the second substrate are on a same axis along the first optical fiber; and
the second substrate is coupled to the second optical fiber.

3. The fiber grating apparatus of claim 1, wherein the metalens assembly includes a metalens.

4. The fiber grating apparatus of claim 3, wherein the metalens assembly further includes a protective film covering the metalens.

5. The fiber grating apparatus of claim 1, wherein:
the filter is a first filter; and
the metalens assembly includes a metalens and a second filter.

6. The fiber grating apparatus of claim 5, wherein:
the second filter is arranged at a surface of the metalens; and
the metalens assembly further includes a protective film completely wrapping the second filter and the metalens.

7. The fiber grating apparatus of claim 1, wherein:
the filter is arranged at the first substrate; and
the first optical fiber, the first substrate, the filter, the metalens assembly, the second substrate, and the second optical fiber are coupled in sequence.

8. The fiber grating apparatus of claim 1, wherein:
the filter is arranged at the first optical fiber; and
the first optical fiber, the filter, the first substrate, the metalens assembly, the second substrate, and the second optical fiber are coupled in sequence.

9. The fiber grating apparatus of claim 1,
the metalens assembly includes a first metalens;
the fiber grating apparatus further comprising:
a second metalens arranged between the filter and the second substrate and coupled to the filter and the second substrate.

10. The fiber grating apparatus of claim 9, further comprising:
a third metalens;
wherein the third metalens and the first metalens are arranged side by side with each other, and between the first substrate and the filter.

11. The fiber grating apparatus of claim 10,
wherein the filter is a first filter;
the fiber grating apparatus further comprising:
a second filter arranged side by side with the first filter to form a filter array corresponding to a metalens array formed by the third metalens and the first metalens; and
a phase retarder arranged between the second substrate and the second metalens.

12. The fiber grating apparatus of claim 9, further comprising:
a third metalens;
wherein the third metalens and the second metalens are arranged side by side with each other, and between the second substrate and the filter.

13. The fiber grating apparatus of claim 12,
wherein the filter is a first filter;
the fiber grating apparatus further comprising:
a second filter arranged between the first optical fiber and the first substrate; and
a phase retarder;
wherein the phrase retarder and the first filter are arranged side by side and corresponding to a metalens array formed by the third metalens and the first metalens.

14. A sensor device comprising:
a fiber grating apparatus including:
a first optical fiber;
an optical wave assembly coupled to the first optical fiber and having grating function, the optical wave assembly including a first substrate, a metalens assembly, a filter, and a second substrate; and
a second optical fiber coupled to the optical wave assembly;
wherein the first optical fiber, the optical wave assembly, and the second optical fiber are arranged on a same plane.

15. The sensor device of claim 14, further comprising:
a first waveguide; and
a second waveguide;
wherein the first optical fiber, the optical wave assembly, and the first waveguide or the second waveguide are coupled in sequence.

16. The sensor device of claim 14, further comprising:
a first waveguide; and
a second waveguide;
wherein the first waveguide, the optical wave assembly, and the second waveguide are coupled in sequence.

17. The sensor device of claim 14, wherein:
the first substrate, the metalens assembly, the filber, and the second substrate are coupled in sequence;
the first substrate, the metalens assembly, the filber, and the second substrate are on a same axis along the first optical fiber; and
the second substrate is coupled to the second optical fiber.

18. The sensor device of claim 14, wherein the metalens assembly includes a metalens.

19. The sensor device of claim 14, wherein:
the filter is a first filter; and
the metalens assembly includes a metalens and a second filter.

20. The sensor device of claim 14, wherein:
the filter is arranged at the first substrate; and
the first optical fiber, the first substrate, the filter, the metalens assembly, the second substrate, and the second optical fiber are coupled in sequence.
